(19) United States
(12) Patent Application Publication
(10) Pub. No.: US 2004/0117288 A1
(43) Pub. Date: Jun. 17, 2004

(54) Method for providing default protection in connection with a deferred compensation liability

(76) Inventor: David Marshall, Milan, NY (US)

Correspondence Address: GREENBERG TRAURIG, LLP, 885 3RD AVENUE, NEW YORK, NY, 10022, US

(21) Appl. No.: 10/649,392

(22) Filed: Aug. 26, 2003

Related U.S. Application Data
(60) Provisional application No. 60/406,294, filed on Aug. 26, 2002.

(51) Int. Cl. G06F 17/60

(52) U.S. Cl. 705/36

(57) ABSTRACT

The present invention relates to a method implemented by a programmed computer system for providing default protection associated with a protection agreement between a protection provider and a participant in a deferred compensation plan, wherein the default protection is on an unsecured general obligation of a party sponsoring the deferred compensation plan arising from the participant's election to defer at least a portion of participant's compensation.

### RELATED APPLICATIONS

This application claims the benefit under 35 U.S.C. 119(e) of U.S. Provisional Application Serial No. 60/406,294 filed Aug. 26, 2002.

### FIELD OF THE INVENTION

The present invention relates to a method for providing default protection (e.g., individual credit default protection) in connection with a deferred compensation liability.

For the purposes of the present application the term “credit event” may include, but not be limited to, bankruptcy, failure to pay an obligation when due, restructuring, obligation default, obligation on acceleration, and/or repudiation/moratorium.

Further, for the purposes of the present application the term “fixed income security” is intended to include, but not be limited to, a bond (such as a fixed income, long dated bond, for example) or some other form of debt instrument.

Further still, for the purposes of the present application the term “agreement” (such as a default protection agreement between a first party and a second party, for example) is intended to include, but not be limited to, a written and/or oral: (a) understanding; (b) contract; (c) arrangement; (d) deal; (e) bargain; (f) covenant; or (g) transaction.

Further still, for each term which is identified herein as “may include” or “intended to include” certain definitions, when such term is used in the claims the term is to be construed more specifically as “intended to include at least one of the definitions”.

### BACKGROUND OF THE INVENTION

A conventional deferred compensation plan is a mechanism by which an executive or other employee of a company may elect to defer payment of compensation until a later date. Taxation of the income to the employee, and the employee's deduction, are typically delayed until payment of the deferred compensation is actually made (i.e., a “distribution” is made). A “present value” or “accrued benefit” is an amount to which the employee is “vested” and to which the employee is entitled to upon distribution (which vested amount represents a liability to the employer). Further, the deferred compensation plan is typically offered through a non-qualified deferred compensation arrangement (i.e., a plan which is not described under section 404(a)(1), (2),or (3) of the U.S. Internal Revenue Code of 1986, as amended (hereinafter the “Code”)) which is accounted for without a specific amount set aside in trust.

Of note, when participant investment direction is permitted, many conventional non-qualified deferred compensation plans offer the plan participants market-based investment benchmarks similar to investment options under a 401(k) program. That is, conventional non-qualified deferred compensation plans offer the plan participants (e.g., employee(s)) the ability to receive a return on deferred compensation as if their deferred compensation were invested in one or more market-based benchmarks such as the S&P 500, the Russell 2000, and/or a particular mutual fund (hereinafter generically referred to as “Mutual Fund A” or “Mutual Fund B”). Although the employee is entitled to receive a payout equal to the value of its deferred compensation as if such amounts were invested in the selected investment benchmarks, neither the employer nor anyone else is under any obligation to actually purchase the benchmark investments. In this way, the employee's deferred compensation may be said to be “notionally” invested in the benchmark investments.

In one specific example of the operation of a conventional deferred compensation plan, an employee may defer $100 of compensation (i.e., the employee will not take the deferred compensation as income) and the employee may elect to receive a return on the deferred amount as if the deferred amount were invested in one or more benchmark investments specified by the deferred compensation plan. The plan allows employees to change periodically the manner in which their deferred compensation is notionally invested prior to the payout date. For example, an employee might defer $100 of compensation and elect to receive a return on that amount as if it were invested in Mutual Fund A. One year later, the value of such an investment might be $110 (such amount is typically known as the employee's “plan balance”). At that time the employee might change its notional investment to reflect a return on its plan balance as if that balance were invested in Mutual Fund B. At the payout date, the employee typically would be entitled to receive an amount equal to its plan balance at that time. This amount due at the payout date represents a liability (hereinafter “NQDC Liability” or “NQDC Obligation”) to the employee owed by the employer.

However, it is understood that NQDC plans are unfunded promises to pay. The employee has no rights of ownership in any asset, hedge, etc. used by an employer to hedge or offset balance sheet liabilities. In other words, the employee is simply a general, unsecured creditor with regard to the employee's plan balance—an unsecured general obligation of a party sponsoring the deferred compensation plan arising from the participant's election to defer at least a portion of participant's compensation. As such, the employee is exposed to various risks (e.g., bankruptcy risk associated with the employer).

Also in the financial area, a “SERP” is a mechanism under which a benefit is paid due to loss under tax qualification limits.

### BRIEF DESCRIPTION OF THE DRAWINGS

FIG. 1 shows the structure of a default protection mechanism according to an embodiment of the present invention;

FIG. 2 shows the mechanics of a default swap according to an embodiment of the present invention;

FIG. 3 shows a chain of events in connection with a default swap according to an embodiment of the present invention; and

FIG. 4 shows a pricing comparison regarding the sale of a default swap vs. the purchase of an asset.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

In one embodiment, the present invention relates to a method implemented by a programmed computer system for providing default protection associated with a protection agreement between a protection provider and a participant in a deferred compensation plan, wherein the default protection is on an unsecured general obligation of a party sponsoring the deferred compensation plan arising from the participant's election to defer at least a portion of participant's compensation, comprising: using the computer to store data relating to the protection agreement between the protection provider and the participant in the deferred compensation plan, wherein the stored data includes a value of the deferred compensation arising from the participant's election to defer at least a portion of participant's compensation; determining, on the computer, whether a credit event associated with a fixed income security issued by the party sponsoring the deferred compensation plan has occurred; obligating the protection provider to make a protection payment to the participant after the computer determines that the credit event occurred, wherein the value of the protection payment is based at least in part upon the stored data including the value of the deferred compensation arising from the participant's election to defer at least a portion of participant's compensation; calculating, on the computer, a protection agreement fee to be paid by the participant to the protection provider; and making a protection agreement fee payment from the participant to the protection provider.

In another embodiment, the fixed income security is a debt instrument. For example, the debt instrument is a bond. More specifically, the bond is a fixed income, long dated bond.

In a further embodiment, the credit event is selected from the group including: (a) bankruptcy; (b) failure to pay an obligation when due; (c) restructuring; (d) obligation default; (e) obligation acceleration; and (f) repudiation/moratorium.

In yet another embodiment, the value of the deferred compensation arising from the participant's election to defer at least a portion of participant's compensation is adjusted by adding to an initial value of the deferred compensation any amounts of additional compensation deferred by the participant less any payments made by the party sponsoring the deferred compensation plan to the participant. For example, the value of the deferred compensation changes over time. More specifically, the value of the deferred compensation changes over time periodically at an interval selected from the group including: (a) daily; (b) weekly; (c) monthly; (d) quarterly; (e) semi-annually; and (f) annually.

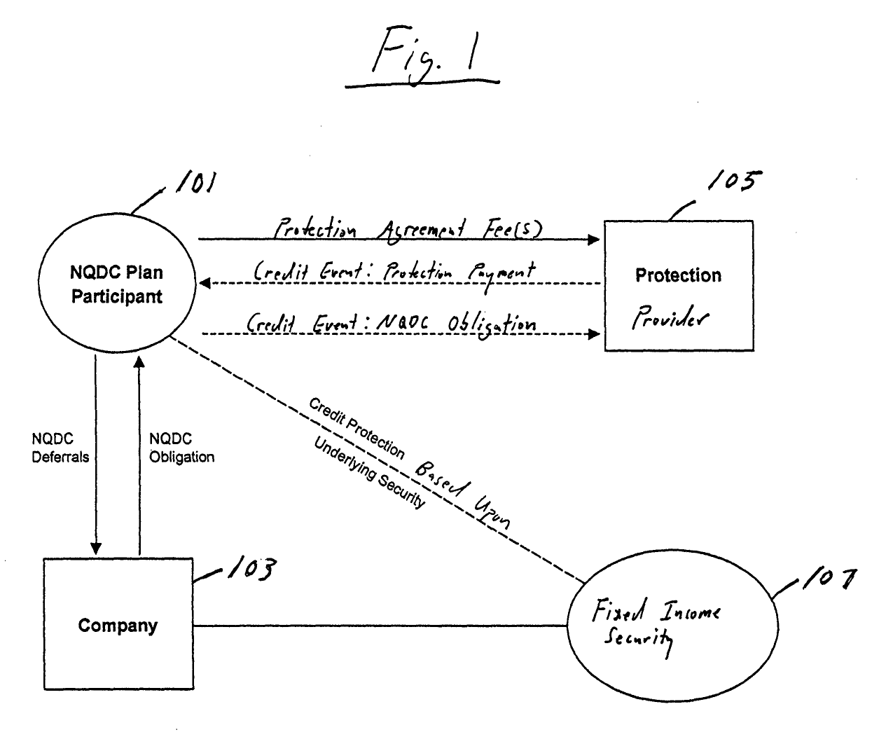

Referring now to FIG. 1, a block diagram of the structure of a default protection mechanism according to an embodiment of the present invention is shown. As seen in this FIG. 1, NQDC Plan Participant 101 (e.g., an employee) may be enrolled in a deferred compensation plan sponsored by Company 103 (e.g., an employer of the NQDC Plan Participant 101), whereby certain “NQDC Deferrals” (i.e., compensation payments) which would ordinarily be made to NQDC Plan Participant 101 are deferred until paid at a later date as “Benefit Payments”. The obligation of Company 103 to make such “Benefit Payments” to NQDC Plan Participant 101 at a later date is shown in this FIG. 1 as “NQDC Obligation” flowing from Company 103 to NQDC Plan Participant 101.

Further, NQDC Plan Participant 101 enter into a default protection agreement with Protection Provider 105. Under such a default protection agreement, Protection Provider 105 is obligated to provide NQDC Plan Participant 101 a certain protection payment (e.g., the par amount of an NQDC plan balance associated with NQDC Plan Participant 101) in the event of a credit event associated with Company 103 as reflected by Fixed Income Security 107. Further, in the event of such a credit event, NQDC Plan Participant 101 is obligated to provide its NQDC Obligation from Company 103 to Protection Provider 105. Finally, in return for receiving this default protection, NQDC Plan Participant 101 is obligated to pay certain protection agreement fee(s) to Protection Provider 105 (e.g., NQDC Plan Participant 101 may be obligated to pay a certain number of basis points per annum to Protection Provider 105 based upon the NQDC plan balance associated with NQDC Plan Participant 101).

Of note, the diagonal dashed line shown between NQDC Plan Participant 101 and Fixed Income Security 107 (which is a fixed income security associated with Company 103, as shown by the horizontal line between the two) is intended to indicate that default protection provided NQDC Plan Participant 101 by Protection Provider 105 is based upon Fixed Income Security 107 and not upon the NQDC Obligation owed NQDC Plan Participant 101 by Company 103.

In other words, in this embodiment of the present invention, the default protection is not directly on the plan balance of NQDC Plan Participant 101 (wherein there may be essentially no liquid market). Rather, the default protection may be on one or more liquid instruments having essentially an equal value to the plan balance associated with NQDC Plan Participant 101. Such liquid instruments may include fixed income securities.

In this regard, one example of the operation of the present invention (which example is intended to be illustrative and not restrictive) may be as follows. Plan Participant 101 (e.g., a CEO of Company 103 ) may have a plan balance of $10,000,000 and Plan Participant 101 may purchase a derivative (e.g., a credit default derivative) from Protection Provider 105 on $10,000,000 worth of bonds (e.g., fixed income, long dated bonds) of Company 103.

In another embodiment of the present invention, Protection Provider 105 may in turn hedge (either fully or partially) its obligation to NQDC Plan Participant 101 under the default protection agreement. Such hedging may be carried out through sale or other means and may be performed on an individual basis (i.e., on a NQDC Plan Participant by NQDC Plan Participant basis) and/or on an aggregate (or portfolio) basis.

In another embodiment of the present invention, the definition of a credit event may be market-driven (wherein the protection provided each NQDC Plan Participant is not customized on a NQDC Plan Participant by NQDC Plan Participant basis).

In another embodiment of the present invention, the default protection is focused (i.e., particularized) to the type of risk being protected.

In another embodiment of the present invention, the default protection may be used by an employee before and/or after retirement (e.g., a CEO of a company may be comfortable with the company's financial state while he or she is acting as CEO, but may be uncomfortable with how the company's financial state is maintained after his or her retirement).

In another embodiment of the present invention, the default protection may permit an NQDC Plan Participant to recover all or part of the NQDC Plan Participant's plan balance.

In another embodiment of the present invention, the default protection may be sold by the Protection Provider and/or the default protection may be sold by a third party on behalf of the Protection Provider.

Referring now to a discussion of credit derivatives (with reference, for example, to relative value, market access, and customization), it is noted that debt instruments of the same credit are often priced differently. More particularly:

Debt instruments with complex cashflows such as structured notes (e.g. leveraged inverse floaters, commodity linked bonds, etc) are often priced cheap relative to plain vanilla instruments.

Debt instruments issued by the same credit but traded in different markets are often priced differently—i.e., traditional bonds vs. convertible bonds vs. bank loans.

Debt instruments may be priced differently because of tax or settlement problems.

Further, it is noted that portfolio products such as CDOs and Portfolio Swaps may allow investors to capture value from the “portfolio effect” and express views on different layers of the capital structure of a diversified portfolio of credits.

In addition, credit derivatives can bridge the structural inefficiencies of the credit markets and create relative value for fixed income investors.

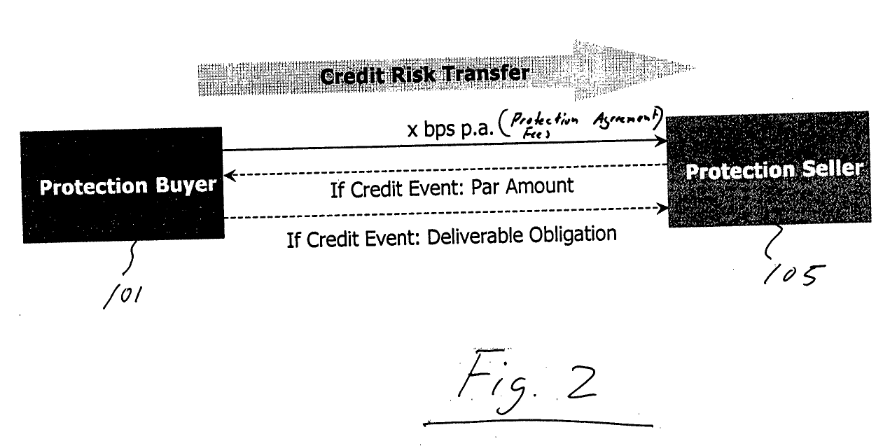

Referring now to FIG. 2, the mechanics of a default swap according to an embodiment of the present invention (involving credit risk transfer) are shown. More particularly:

If no Credit Event occurs, the only cash flow is the premium paid by the buyer to the seller

If a Credit Event occurs, the premium payments stop and the transaction is settled either physically or through a cash valuation mechanism

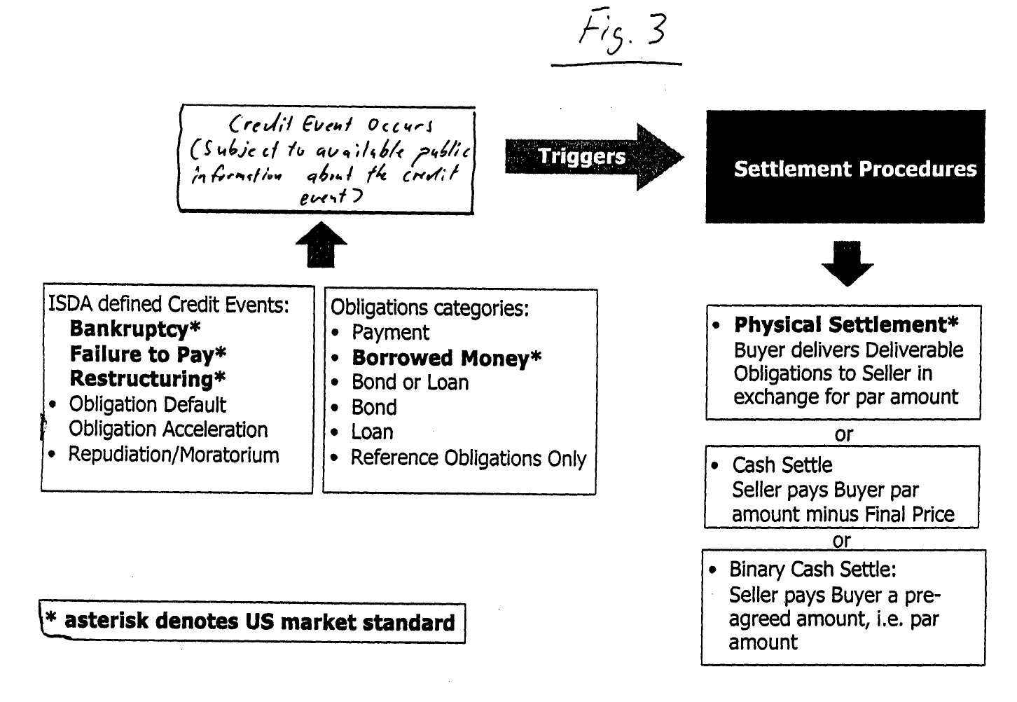

Referring now to FIG. 3, a chain of events in connection with a default swap according to an embodiment of the present invention is shown.

Referring now to Table 1, below, certain characteristics of default swaps versus bonds are shown (in this regard, it is noted that trading bonds is typically considered buying and selling credit risk and that trading default swaps should typically be considered buying and selling credit protection)

TABLE 1

| Long Credit Risk | Short Credit Risk |
|---|---|
| Buy Bonds | Buy Protection |
| Sell Protection | Sell Bonds |

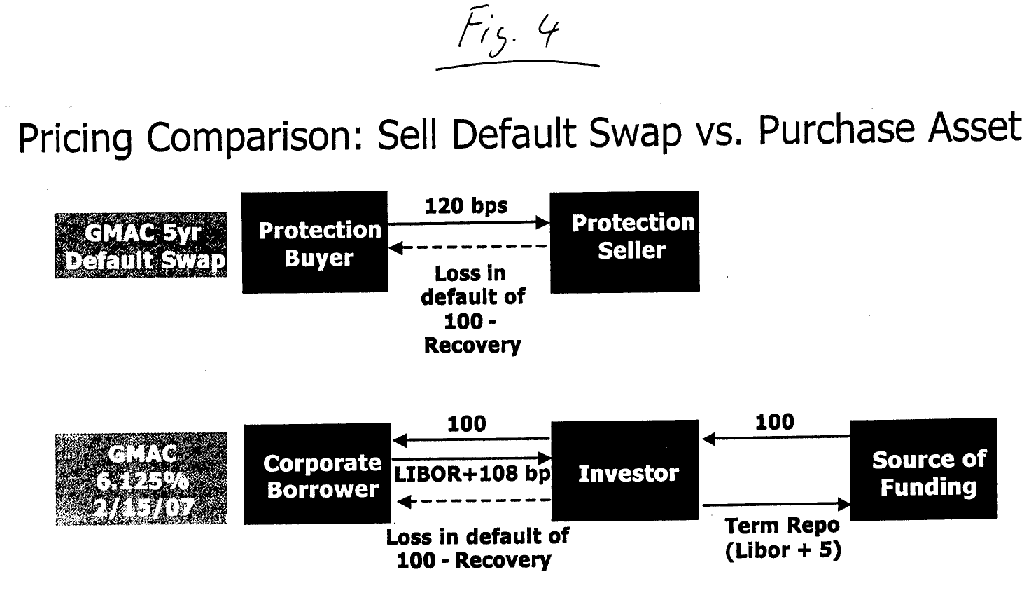

Referring now to FIG. 4, a pricing comparison regarding the sale of a default swap vs. the purchase of an asset is shown. As seen in this FIG., the default premium should theoretically be (LIBOR+ floating rate spread) minus (term secured financing rate to maturity). The “rule of thumb” is to compare default swaps to a bond's spread to LIBOR. In this example, investor is paid 120 bppa to take GMAC credit risk via default swaps, versus 103 bpaa (108-5) to take GMAC credit risk via buying the bonds and obtaining funding.

Referring now to explanations for the default swap/bond basis. It is noted that:

A difference in spreads on the same underlying credit is generally the result of factors besides dislocated markets

The more common, or “natural state” of the market is for default swaps to trade at wider spreads than bonds, known as a “positive basis”

Less frequently, “negative basis” trades exist, and they are generally driven by technical factors

In this regard, Table 2, below, shows certain characteristics of positive basis and negative basis.

TABLE 2

| Positive Basis (cheap to cash) | Negative Basis (rich to cash) |
|---|---|
| High demands for credit protection - | Lack of desired exposure in debt |
| market of hedgers is expansive | market |
| Cheapest-to-deliver optionality | Synthetic CDOs |
| Difficult and expensive to short | |
| credit in debt market | |
| Structured notes | |
| Stripped converts | |

Referring now to liquidity issues, it is noted that:

Generally speaking, liquidity of credit derivatives (“CDS”) market has grown substantially and continues to improve

However, in many instances as a particular credit deteriorates, its liquidity dries up in the CDS market before cash market

One reason is the CDS market simply has fewer players

For distressed names, CDS market may seem more “final” than cash market, i.e., contract is over and cannot be traded once default occurs

Distressed market also often sees asset-specific recovery plays

Arguably, with increasing frequency liquidity is actually better in CDS than cash market, e.g.: Enron, Thomas and Betts, Noble Affiliates, Avnet, CNA Financial, Arrow, Coming, Computer Sciences, Delphi

The positive basis generally further widens as credit quality impairs, often driven by repo costs

Referring now to payment methodology, it is noted that:

Once a credit is severely impaired, it becomes difficult or impossible to trade default swaps on a running spread. They are typically quoted on some sort of “points upfront” basis, where the premium is either prepaid completely or in part at the beginning of the swap

Factors to consider in running/upfront quotes:

At what discount is corresponding debt priced?

What is your “loss” in default on the debt versus default swaps? In credit improvement?

What are the implications of recovery rate on upfront vs. running payments?

Referring now to unwind valuation (e.g., marking or trading out of position), it is noted that generally, unwind valuation is approximated according to the following methodology:

Calculate the net future cashflows

Discount each cashflow by LIBOR at each time period

Then discount each LIBOR-discounted cashflow by a survival probability, which can be approximated from spread and recovery assumptions. Using the same spread (i.e., assuming a flat credit curve) to approximate survival probability may introduce error in the calculation for steeply upward or downward-sloping yield curves

Add these discounted cashflows for a Net Present Value (NPV) for the existing trade

Referring now to market standardization it is noted that:

In connection with a Reference Entity:

Armstrong World filed for bankruptcy in May 2001.

Many contracts were written on the wrong Reference Entity—Armstrong Holdings Inc. instead of Armstrong World.

Highlighted the importance of the contractual nature of default swaps and prompted Project RED (Reference Entity Database).

In connection with Modified Restructuring:

Conseco restructured a bilateral loan in August 2000 which also became structurally senior in claim to unsecured debt.

Default swap contracts triggered and settled, despite a 20+ point cheapest-to-deliver optionally and the fact that no other credit event subsequently occurred.

Led to the adoption of the May 2001 Restructuring Supplement in the United States.

In connection with Convertible Bond Delivery Language:

The rapid growth of the credit derivatives market was fueled by new entrants to the market. This included convertible arbitrage funds, who view buying default protection as a viable alternative to selling stripped converts in order to source cheap volatility.

Explosive CDS market growth coincided with historically high convert issuance since late 2000.

Original ISDA 99 definitions were ambiguous on the deliverability of convertibles into the contract. Sellers of protection feared receiving an equity claim, while buyers feared not being able to deliver their convertible bonds.

Led to the adoption of ISDA November 2001 Convertible Supplement.

In connection with Successor Language:

In London, National Power PLC announced in the fall of 2000 that they would break into two independent companies—one responsible for its power generation domestically to be named Energy, and one which controlled its foreign businesses to be named International Power. National Power PLC sold the majority of its assets to Energy, and its Certificate of Incorporation was given to International Power, even though International Power comprised only 20% of the total business revenue of its predecessor.

Though there was never a Credit Event on either Successor, the difference in ratings (4 notches) and spreads (˜200 bps) drew attention to the ambiguity of successor language in ISDA 99 definitions. Raised the debate whether “Obligations” should refer to debt or assets.

Led to adoption of ISDA November 2001 Successor Language Supplement.

Reference will now be made to certain example termsheet definitions (which example definitions are intended to be illustrative and not restrictive) which may be used in a credit derivative transaction according to an embodiment of the present invention. More particularly, such definitions may include, but not be limited to:

General Terms

Trade Date: the date on which Buyer and Seller enter into the Credit Derivative Transaction (when you say “done”).

Effective Date: the date on which both accruals and credit protection start, typically three business days after Trade Date.

Scheduled Termination Date: the date on which accruals end and the protection expires assuming the contract has not been triggered.

Floating Rate Payer: the “Seller” of credit protection (similar to being long bonds). The payment the Seller makes in the transaction is not fixed in dollar terms at the onset of the contract, but depends on whether a credit event occurs and where the entity recovers.

Fixed Rate Payer: the “Buyer” of credit protection (similar to being short bonds). The Buyer is obliged to make one or more payments of a Fixed Amount (known on Trade Date), typically as a percentage of the notional of the contract. Payments are generally made quarterly.

Calculation Agent: party specified (or if not specified, Seller) who, if necessary, is responsible for determining Successor and some administrative functions that include obtaining Quotations for Final Price for Cash Settlement.

Business Day: a day on which commercial banks and foreign exchange markets are generally open to settle payments. Market standard in the United States is New York and London.

Business Day Convention: the manner for adjusting any relevant date if it would otherwise fall on a day that is not a Business Day. Market standard globally is Modified Following, meaning the date will be the next following Business day unless that day falls in the next calendar month, in which case the date will be the first preceding Business Day.

Reference Entity: the exact legal name for the Entity whose obligations trigger credit events.

Reference Obligation(s): an obligation of the Reference Entity specified in the contract for the purpose of establishing a point in the capital structure on which the Default Swap is based. The Reference Obligation sets the benchmark for pari passu ranking in obligations that can be delivered in default. An example Reference Obligation (which example is intended to be illustrative and not restrictive) may be as follows:

Primary Obligor: AOL Time Warner Inc.

Guarantor: America Online, Inc.

Maturity: Apr. 15, 2011

Coupon: 6.750%

CUSIP: 00184AAB1

Original Issue Amount: USD: $1,000,000,000

Reference Price: may be, for example (which example is intended to be illustrative and not restrictive), 100%.

Fixed Payment

Fixed Rate Payer Calculation Amount: notional of the contract on which fixed rate calculations are made.

Fixed Rate Payment Date(s): may be any desired payment date(s).

Fixed Rate: the “coupon rate”, expressed in percentage terms or basis points per annum, applied to the notional of the contract on payment dates.

Fixed Rate Day Count Fraction: applied to Fixed Rate to determine Fixed amount. Market standard globally is actual/360.

Floating Payment

Floating Rate Payer Calculation Amount: notional equivalent to the par amount of obligations.

Conditions to Payment: specifications of how to properly trigger a Default Swap Contract. Market standard typically is the following:

Notifying Party: part(ies) entitled to trigger the contract. Standard is Buyer or Seller.

Credit Event Notice: the Notifying party must give an irrevocable notice, written or oral, that a Credit Event has occurred after the Effective Date and prior to the Scheduled termination date.

Notice of Intended Physical Settlement: Buyer must give an irrevocable notice to Seller within thirty calendar days of the Credit Event Notice describing the obligation(s) the Buyer “reasonably expects” to deliver to Seller.

Notice of Publicly Available Information: the Notifying party must provide an irrevocable notice with the Credit Event Notice that cites Publicly Available Information confirming the Credit Event, generally from two separate sources.

Publicly Available Information: information that has been published in internationally recognized news sources; information from a trustee or fiscal agent, or information contained in a notice from a regulatory, administrative, or judicial body. One or more public sources maybe specified.

Credit Events: defines the events which allow for triggering the default swap. Current US market standard is Bankruptcy, Failure to Pay, and modified Restructuring.

Bankruptcy: the Reference Entity is dissolved, unable to pay its debts, makes a general assignment for the benefit of its creditors, or has bankruptcy judgment awarded against it

Failure to Pay: the Reference Entity fails to make any payments in an amount not less than the Payment Requirement

Grace period extension: may or may not apply.

Payment Requirement: any desired payment amount. For example (which example is intended to be illustrative and not restrictive) USD $1,000,000 (or its equivalent in the Obligation Currency as of the occurrence of the relevant Credit Event).

Obligation Acceleration: Obligations of the Reference Entity become due and payable prior to maturity on an amount not less than the Default Requirement.

Obligation Default: Obligations of the Reference Entity become capable of becoming due and payable prior to maturity on an amount not less than the Default Requirement.

Repudiation/Moratorium: the Reference Entity or government challenges the validity of an Obligation or declares a standstill. Typically included in contracts on sovereigns.

Restructuring: the interest or principal payments on an obligation are altered, postponed, changed in priority, or in someway altered due to deterioration of creditworthiness.

Default Requirement: for example (which example is intended to be illustrative and not restrictive) USD $10,000,000 (or its equivalent in the Obligation Currency as of the occurrence of the relevant Credit Event).

Obligations: Categories and characteristics define what types of Obligations can trigger the default swap and what obligations can be delivered in the case of physically settled default swaps.

Category: specifies the type of Obligation that the Credit Events will apply to in order to trigger the contract. Market standard is Bonds or Loans. From broadest to most specific, the obligation categories are:

Payment: obligation for the payment or repayment of money, including, without limitation, Borrowed Money

Borrowed Money: obligation of Payment type with respect to borrowed money

Bond or Loan

Bond: obligation in Borrowed Money category in form of bond, note, or other debt security

Loan: obligation in Borrowed Money category documented by loan agreement

Reference Obligations Only

Obligation Characteristics: Specifies the characteristics necessary to the Obligation in order to trigger a credit event, or in order to deliver in the case of Physical Settlement

Settlement Terms

Settlement Method: in the event that the contract is triggered, the manner in which the Seller compensates the Buyer of protection. Most typical convention is

Physical Settlement; other types of settlement include Cash Settlement and Binary Settlement

Physical Settlement Period: for example (which example is intended to be illustrative and not restrictive) 30 Business Days or longest number of Business Days in accordance with the then market practice of Obligation being delivered

Portfolio: Deliverable Obligations of an outstanding principal balance with a market standard of excluding accrued interest

Deliverable Obligation Characteristics: Obligations delivered in a Physical Settlement must comply with all specified characteristics. The following are market standard:

Paris Passu Ranking: ranks at least pari passu (equal to) the most senior Reference Obligation

Specified Currency: obligation payable in currencies listed; standard are G7 and euro

Not Contingent: repayment of principal is not subject to amount determined by formula or reference and which bears an interest at a rate that is paid on a periodic basis on a fixed amount or computed with reference to benchmark

Assignable Loan: loan that can be assigned by any third party that is not then a lender or member of the syndicate

Consent Required Loan: loan that can be assigned with consent of Reference Entity or guarantor

Transferable: obligation that is transferable to institutional investors without any contractual, statutory, or regulatory restriction

Maximum Maturity: typically 30 years

Not Bearer

Partial Cash Settlement: refers to ability to go to cash settlement if some part of a loan or participation cannot be transferred because consents are not secured in time, etc.

Restructuring Maturity Limitation: may or may not apply.

Partial Cash Settlement of Loans: may or may not apply.

Partial Cash Settlement of Assignable Loans: may or may not apply.

Partial Cash Settlement of Participations: may or may not apply.

Dispute Resolution: may or may not apply.

Other Terms

Restructuring Supplement: language approved by ISDA in May 2001 to incorporate enhancements to Restructuring definition as noted earlier, which defines Restructuring Maturity Limitation Date as well as clarifies the definition of Pari Passu Ranking

Supplement Relating to Convertible, Exchangeable or Accreting Obligations:

language approved by ISDA in November 2001 to allow delivery of convertible, exchangeable, and accreting obligations when delivered as fixed income claims and as a percentage of the Outstanding Principal Balance

Supplement relating to Successor and Credit Events: approved by ISDA in November 2001 to give specific format to determining the course of a Credit Derivative Transaction if any or all of the obligations of a Reference Entity are succeeded by one or more entities

Referring now to some specifics on restructuring, it is noted that in connection with certain “old-style restructuring” the following events typically resulted directly or indirectly from a deterioration in credit worthiness or financial condition: a) reduction in rate or amount of interest payable; b) reduction in principal or premium payable at maturity; c) postponement of payments; d) change in ranking in priority of payment causing subordination of Obligation; e) change in currency of payment of interest or principal.

In this regard, issues were raised regarding the effectiveness of old-style restructuring after the Conseco default.

Accordingly, new “modified restructuring”:

Limits Deliverable Obligation in the event that Restructuring is the trigger

Limits Deliverable Obligation to Multiple Holder Obligation

Defines Restructuring Maturity Limitation Date

Buyer of default protection must trigger contract in order for Modified Restructuring language to be applicable

Permits triggering of default swap contract in $1 million increments

In another embodiment, the credit event may be identified by one (or more) of: (a) the participant; (b) the protection provider; and/or (c) a third party.

In another embodiment, the participant may transfer a right to receive at least a portion of the vested value of the plan balance to the protection provider.

In another embodiment, the value of the protection payment and the value of the right transferred to the protection provider may be substantially equal.

In another embodiment, the protection payment may substantially equal the vested value of the plan balance and the participant may transfer a right to receive all of the vested value of the plan balance to the protection provider.

In another embodiment, the present invention may further comprise making at least one protection agreement fee payment from the participant to the protection provider.

In another embodiment, the protection agreement fee payment may be in an amount selected from the group of (but not limited to): (a) a fixed amount; and (b) an amount based upon the vested value of the plan balance.

In another embodiment, the protection agreement fee may be paid once.

In another embodiment, the protection agreement fee may be paid periodically.

In another embodiment, the protection agreement fee may be paid periodically at an interval selected from the group including (but not limited to): (a) daily; (b) weekly; (c) monthly; (d) quarterly; (e) semi-annually; and (f) annually.

In another embodiment, the present invention may further comprise hedging the protection payment made from the protection provider to the participant.

In another embodiment, the protection provider may hedge the protection payment by obtaining a call on the fixed income security.

In another embodiment, a method of finance is provided, comprising: engaging a protection provider and a participant in a deferred compensation plan in a protection agreement; identifying the occurrence of a credit event associated with a bond issued by a party sponsoring the deferred compensation plan, which credit event is selected from the group including (but not limited to): (a) bankruptcy; (b) failure to pay an obligation when due; (c) restructuring; (d) obligation default; (e) obligation on acceleration; and (f) repudiation/moratorium; making a protection payment to the participant from the protection provider after the credit event associated with the security is identified; and making at least one protection agreement fee payment from the participant to the protection provider, which protection agreement fee payment is in an amount selected from the group of (including, but not limited to): (a) a fixed amount; and (b) an amount based upon a vested value of a plan balance associated with the participant under the deferred compensation plan; wherein the credit event is identified by at least one of (including, but not limited to): (a) the participant; (b) the protection provider; and/or (c) a third party; wherein the protection payment equals at least a portion of the vested value of the plan balance; wherein the participant transfers a right to receive at least a portion of the vested value of the plan balance to the protection provider; and wherein the value of the protection payment and the value of the right transferred to the protection provider are substantially equal.

Of note, under the present invention the default protection can not be arranged by the Company (i.e., the Company may not be involved in the risk transfer). Rather, the default protection may be arranged by the NQDC Plan Participant, for example.

Of further note, the method embodiments described herein may, of course, be implemented using any appropriate computer hardware and/or computer software. In this regard, those of ordinary skill in the art are well versed in the type of computer hardware that may be used (e.g., a mainframe, a mini-computer, a personal computer (“PC”), a network (e.g., an intranet and/or the Internet)), the type of computer programming techniques that may be used (e.g., object oriented programming), and the type of computer programming languages that may be used (e.g., C++, Basic). The aforementioned examples are, of course, illustrative and not restrictive.

While a number of embodiments of the present invention have been described, it is understood that these embodiments are illustrative only, and not restrictive, and that many modifications may become apparent to those of ordinary skill in the art. For example, certain methods have been described herein as being “computer implementable”. In this regard it is noted that while such methods can be implemented using a computer, the methods do not necessarily have to be implemented using a computer. Also, to the extent that such methods are implemented using a computer, not every step must necessarily be implemented using a computer. Further, while the present invention has been described primarily with reference to a single Plan Participant, any desired number of Plan Participants may, of course, be enrolled in the deferred compensation plan. Further still, while the present invention has been described primarily with reference to a single Fixed Income Security, any desired number of Fixed Income Securities may, of course, be utilized. Further still, the default protection may be based on one or more assets and/or securities other than a Fixed Income Security. Further still, the payment of the protection agreement fee(s) to the Protection Provider from the Plan Participant may be made once or may be made multiple times (e.g., on predetermined calendar dates and/or periodically, such as monthly, quarterly, or yearly, for example). Further still, the Company may be a publicly held corporation with one or more non-qualified deferred compensation plans. Further still, the Company may be a closely held corporation with one or more non-qualified deferred compensation plans. Further still, the default protection mechanism may utilize any desired derivative (e.g., a credit default derivative or a credit swap). Further still, the default protection mechanism may operate essentially as a synthetic. Further still, the protection agreement may specify, specifically, which instrument(s) (e.g., debt instrument(s)) of the company is associated therewith. Further still, the protection agreement may be fixed or entered into at a certain time and may be renewable at certain time(s) (e.g., periodically (such as 1 or 3 year intervals for example)). Further still, the protection agreement may utilize a cap on liability thereunder. Further still, while the present invention has been described principally with respect to a method for providing default protection in connection with a deferred compensation liability, a corresponding software program and/or system (e.g., computer system) may of course be utilized to provide default protection in connection with a deferred compensation liability or to help to provide default protection in connection with a deferred compensation liability.

What is claimed is:

1. A method implemented by a programmed computer system for providing default protection associated with a protection agreement between a protection provider and a participant in a deferred compensation plan, wherein the default protection is on an unsecured general obligation of a party sponsoring the deferred compensation plan arising from the participant's election to defer at least a portion of participant's compensation, comprising:
using the computer to store data relating to the protection agreement between the protection provider and the participant in the deferred compensation plan, wherein the stored data includes a value of the deferred compensation arising from the participant's election to defer at least a portion of participant's compensation;
determining whether a credit event associated with a fixed income security issued by the party sponsoring the deferred compensation plan has occurred;
obligating the protection provider to make a protection payment to the participant after the credit event occurred, wherein the value of the protection payment is based at least in part upon the stored data including the value of the deferred compensation arising from the participant's election to defer at least a portion of participant's compensation;
calculating, on the computer, a protection agreement fee to be paid by the participant to the protection provider; and
making a protection agreement fee payment from the participant to the protection provider.

2. The method of claim 1, wherein the fixed income security is a debt instrument.

3. The method of claim 2, wherein the debt instrument is a bond.

4. The method of claim 3, wherein the bond is a fixed income, long dated bond.

5. The method of claim 1, wherein the credit event is determined on the computer and is selected from the group including: (a) bankruptcy; (b) failure to pay an obligation when due; (c) restructuring; (d) obligation default; (e) obligation acceleration; and (f) repudiation/moratorium.

6. The method of claim 1, wherein the value of the deferred compensation arising from the participant's election to defer at least a portion of participant's compensation is adjusted by adding to an initial value of the deferred compensation any amounts of additional compensation deferred by the participant less any payments made by the party sponsoring the deferred compensation plan to the participant.

7. The method of claim 6, wherein the value of the deferred compensation changes over time.

8. The method of claim 7, wherein the value of the deferred compensation changes over time periodically at an interval selected from the group including: (a) daily; (b) weekly; (c) monthly; (d) quarterly; (e) semi-annually; and (f) annually.

9. The method of claim 1, further comprising making the protection payment to the participant from the protection provider after the computer determines that the credit event occurred.

10. The method of claim 9, further comprising obligating the participant to provide the unsecured general obligation of the party sponsoring the deferred compensation plan to the protection provider.

11. The method of claim 1, wherein the steps are performed in the order recited.
